(19) United States
(12) Patent Application Publication
(10) Pub. No.: US 2012/0288662 A1
(43) Pub. Date: Nov. 15, 2012

(54) WATERPROOF BREATHABLE STRETCHABLE COMPOSITE MATERIAL

(76) Inventor: Brian John Conolly, New South Wales (AU)

(21) Appl. No.: 13/481,222

(22) Filed: May 25, 2012

Related U.S. Application Data
(63) Continuation of application No. PCT/AU2010/001603, filed on Nov. 30, 2010.

(30) Foreign Application Priority Data
Nov. 30, 2009 (AU) 2009905845
Aug. 27, 2010 (AU) 2010903853

(51) Int. Cl. B32B 3/26; B32B 15/00; A41D 1/00; D04H 11/00; B32B 33/00; B32B 3/24; B32B 15/082

(52) U.S. Cl. 428/87; 428/137; 428/319.1; 428/457; 428/221; 428/463; 428/96; 2/455

(57) ABSTRACT

An apparel constructed from various combinations of layers of materials with selected thermal and moisture transfer properties in order to provide improved performance characteristics. The inner layers manage the body heat of an individual by reflection and thermal retention while also providing moisture wicking and antimicrobial function. The middle layers manage thermal isolation from the external temperatures by using materials with very low thermal conductivity in combination with waterproof layers that can also be breathable. The outer layers manage external durability, water repellency and waterproofness. The apparel can be constructed with all layers made into one material and in one garment, or constructed as two garments with one being for body heat thermal function and one being for weather insulation and reflection function. The material is made to be optionally form fitting with high stretch.

### CROSS-REFERENCE TO RELATED APPLICATIONS

The present application is a continuation of pending International Patent Application PCT/AU2010/001603 filed on Nov. 30, 2010, which designates the United States and claims priority from the following applications: AU 2010903853 filed Aug. 27, 2010 and AU 2009905845 filed Nov. 30, 2009. The content of all prior applications is incorporated herein by reference.

### FIELD OF THE INVENTION

The present invention relates to composite materials for the construction of apparel (garments) which are particularly suited for applications where an individual needs to be protected from the cold and/or wet environment. Particularly, the present invention relates to composite materials for the construction of apparel constructed having a series of layers, with properties that combine to provide water repellency, waterproofness, breathability, antimicrobial function, high insulation from outside temperature, body heat reflection, body heat conduction, body heat retention and moisture wicking while also being lightweight, comfortable and aesthetically pleasing in appearance.

### BACKGROUND OF THE INVENTION

Various types of apparel material are known in the prior art. Unfortunately, these materials have a number of deficiencies, especially in their thermal properties.

In particular, the types of apparel known in the prior art do not combine the specific new advances in materials detailed in this present invention in order to provide improved thermal properties whilst maintaining several of the appropriate wearing qualities of apparel.

### SUMMARY OF THE INVENTION

In accordance with a first aspect of the present invention, there is provided a water resistant, nonwoven composite for apparel or footwear including: a layer of high thermal insulation provided using a 3D spacer fabric, perforated foam or aerogel; protected by one or more waterproof membranes. Preferably the composite includes a high stretch and breathable nature.

Preferably, the composite includes a metallic aluminum or silver fibre heat reflection layer combined with a thermal heat retention layer of synthetic hollow fleece. At least one of the layers preferably can include an antimicrobial treatment. Preferably the composite also includes an inner heat conduction layer with high wicking moisture management and heat equalizing properties, the inner heat conduction layer made of a natural or polyester fiber with heat conducting property or with the addition of some heat conducting thread.

In accordance with a second aspect of the present invention, there is provided a composite material that includes a metallic aluminium or silver coating as a heat reflection layer combined with a thermal heat retention layer of synthetic hollow core fleece or wool. At least one of the layers preferably can include an antimicrobial treatment. Preferably the composite also includes an inner layer with high wicking moisture management. The metallic coating layer provides a conductive layer that will also help to equalize the heat across the body.

In accordance with a further aspect of the present invention, there is provided apparel for clothing an individual, comprising, on at least a portion of the apparel, a combination of layers constructed in accordance with the preceding paragraphs.

In accordance with a further aspect of the present invention, there is provided apparel for clothing an individual comprising of a high stretch inner garment combined with a low stretch outer shell, where the two garments together provide a thermal system where the outer layer acts as a water repellent insulating shell made in a fabric composite and the inner high stretch garment is a hollow core fleece with a heat reflection layer.

Preferably the composite also includes an inner heat conduction layer with high wicking moisture management and heat equalizing properties, made of a natural or polyester fiber with heat conducting property or with the addition of a heat conducting thread.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 generally illustrates the composite layers that are a result of a preferred embodiment of the present invention, namely a first (outer) weather layer 10, a second waterproof layer 20, a third insulation layer 30, a fourth waterproof layer 40, a fifth protective layer 50, a sixth heat reflective layer 60, a seventh thermal layer 70 and an eighth (inner) heat conductive/wicking layer 80.

FIG. 2 illustrates how the layers in FIG. 1 combine to make a flexible system of two fabrics combined for use in two garments, an outer weather shield and insulator combined with an inner thermal garment.

FIG. 3 Illustrates an example material made up of layers 10,20,30,40,60 and 70.

FIG. 4 Illustrates apparel as a combination of top 100 and long john style suit 200.

FIG. 5 Illustrates apparel as a combination of a stretchy tight fitting inner technical top 300 and outer shell jacket 400 utilizing the flexible garment system layers per FIG. 2.

### DETAILED DESCRIPTION OF THE INVENTION

The preferred embodiments of the present invention have recognized the deficiencies in the apparel of the known prior art and designed new apparel that is capable of overcoming those deficiencies. More specifically, the preferred embodiments disclose a carefully selected combination of specific fibers, fabrics and material layers with thermal and moisture transfer properties that provide improved performance characteristics, while at the same time providing comfort to the individual wearing the apparel.

The apparel of the preferred embodiments provide an inner thermal system with improved body heat retention. The apparel of the preferred embodiments provide a middle thermal system with improved insulation between the inner body and the external weather. The apparel of the preferred embodiments provide a combination of improved thermal systems while retaining good wicking away and transfer of body moisture, breathability, and antimicrobial function. The apparel of the preferred embodiments provide a combination of improved thermal systems while retaining good stretch for improved body heat retention though form fitting garments.

Optionally, the apparel of the preferred embodiments provide a variation where the apparel can be conveniently worn as two garments together or separately, with the internal thermal system provided in a garment with high stretch for improved body heat retention and the outer thermal system provided weather insulation in a garment as an outer shell.

The apparel of the preferred embodiments provide individuals involved in watersport activities such as sailing, kayaking, surfing, boating, water skiing, wakeboarding, kitesurfing, sailboarding, with active wear with increased performance and function to deal with cold and wet weather conditions while involved in such activities. The apparel of the preferred embodiments individuals involved in outdoor activities such as snowboarding, snow skiing, hiking, climbing, biking, playing golf etc., with active wear with increased performance and function to deal with cold and wet weather conditions while involved in such activities. The apparel of the preferred embodiments provide a combination of nonwoven and foam-like materials, coatings and fabrics-like materials resulting from the latest technological advances in a manner unknown in the prior art.

It should be understood that these embodiments are set forth for purposes of explanation only and are not to be interpreted as the only application of the present invention.

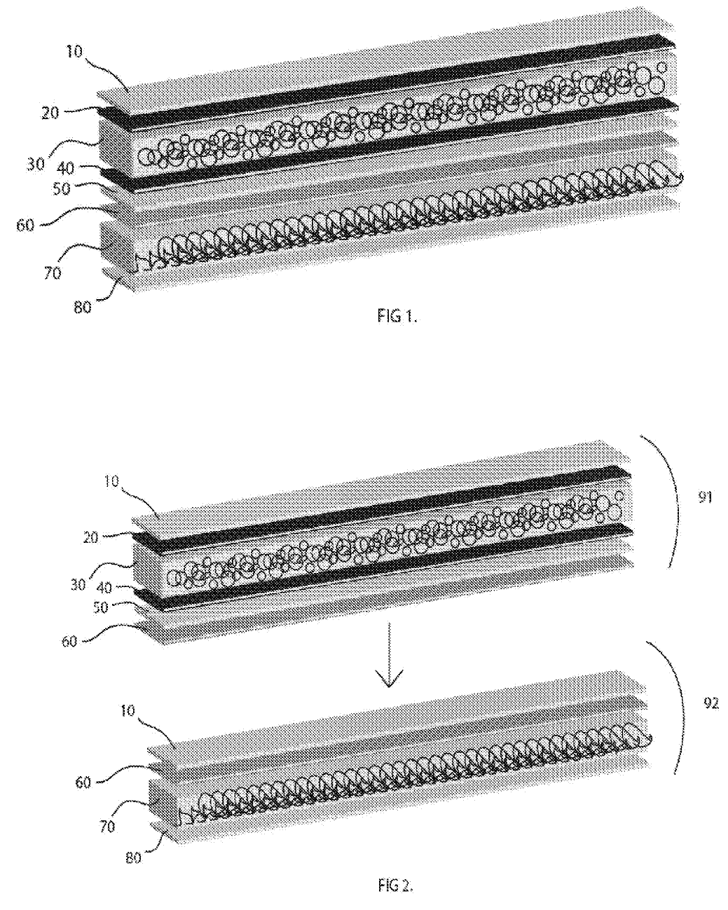

FIG. 1. generally illustrates the composite layers that are a result of a preferred embodiment of the present invention, namely a first (outer) weather layer 10, a second waterproof layer 20, a third insulation layer 30, a fourth waterproof layer 40, a fifth protective layer 50, a sixth heat reflective layer 60, a seventh thermal layer 70 and an eighth (inner) heat conductive/wicking layer 80. On some preferable options one or more layers are eliminated. These layers can be attached to each other either by an adhesive (breathable adhesive if necessary), mechanical bonding (or stitch bonding), lamination (flame or adhesive lamination, for example), welding or a combination of these applications.

An adhesive film that eliminates stitching by SewFree may be used to bond fabrics and seams, pocket areas or collars or adhesive bonding by Bemis or the like can attach the seams. Mechanical bonding can be performed using nylon, elastine, SPANDEX (Trade Mark) or LYCRA (Trade Mark) thread or the fibers inclusive in the nonwoven or fabric structure or the like. Other equivalent methods may also be employed.

A detailed discussion of the materials preferably used in these layers follows. Also follows are some specific examples with some layers eliminated.

The outer material 10 is typically a NYLON (Trade Mark) fabric with a durable water repellent treatment. For example exterior shell performance fabrics and materials manufactured by Schoeller, Amaterrace, Polartec, Gore Enterprises, Nam Liong, Toray, Teijin Shojin and the like. The outer layer 10 can be treated for durable water repellency using a Teflon (Trade Mark) treatment or the like or encapsulation or nano-technology such as described in U.S. patent application Ser. No. 10/002,513 or NANOSPHERE (Trade Mark) technology by Schoeller textile or the like.

The waterproof membrane layer 20 can be a thin waterproof breathable membrane like those available by Toray (for example Dermizax), Schoeller, 3M, etc. or it can be a non-breathable foam layer such as a thin neoprene (preferably 0.5 mm). This layer protects the other inner layers from water under pressure, and can be eliminated if other layers already provide waterproofness.

The insulation layer 30 material is chosen dependant on the performance required. If the performance of the material is designed to have good isolation between the outside temperature and the inside body heat, then this layer 30 should have a very low thermal conductivity. Air has a relatively low conductivity (0.025 W/mK at 20 degrees C. sea level atmospheric pressure), so materials with a high component of air are a good choice.

Layer 30 can be, for example, a 3D warp knit mesh, providing high component of air as a good insulator of heat conduction, and hence good thermal isolation between outer and inner layers. A 3D textile of this kind is usually constructed in three layers and includes a top layer and a bottom layer with “spacer fibers” between them which determine the thickness of the 3D textile. The thickness of such standard commercial 3D textiles can range from 1 mm to over 20 mm. Polyester or polyamide fibers are typically used for the 3D textiles. Special sweat-absorbing materials may also be incorporated in the 3D textiles. Known examples of such 3D textiles include “AirX 3D Spacer Fabric” from the company Tytex, “Spacetec” from Heathcoat, “XD-Spacer Fabrics” from Baltex, and “3 mesh” from Muller-Textil.

Insulation layer 30 can also preferably be a composite of a silicon foam or aerogel, like those provided by Aspen Aerogels, or an Aerogel/PTFE composite insulating material like that described by Gore Enterprises in U.S. Pat. No. 7,118,801. Aerogel is the solid with the lowest thermal conductivity, and can provide higher performance of insulation with a thinner material. It is brittle in standard silcon foam form, and can also release toxic dust. Forms by Aspen Aerogel and Gore Enterprises, however, are new forms that can be used embedded in apparel, and it is expected that further improvements will develop. It is important to only utilize an aerogel that has low dusting or is protected from the skin for toxicity.

Insulation layer 30 can also be a perforated neoprene of various thickness, from 0.5 mm to 7 mm or higher. The perforations can be of various diameter and also spaced at various density. More perforations and/or larger perforations per area of neoprene, or similar foam, will increase the proportion of air in the layer and hence decrease the thermal conductivity and increase the insulation effect.

Insulation layer 30 may also be a thick coating of a foam or a foam blended with a highly insulating material particle. The particle can be in the form of a powder, short fibre, sphere, platelet or other suitable particle form. Particles can be organic or inorganic and can include phase change materials. The coating can be a single layer or multiple layers of similar or different composition. The layer may be printed on in a pattern so as to provide improved fabric properties including increased stretch or breathability or flexability.

Layer 30 may also be of a textile structure made by knitting, weaving or nonwoven and is made from fibres with a hollow core or high air retention structure. These fibres can be either synthetic or natural and could include fibres such as 3DG and camel hair.

The waterproof membrane layer 40 can be a thin waterproof breathable membrane like those available by Toray (for example Dermizax (Trade Mark)), Schoeller, 3M, etc. or it can be a non-breathable foam layer such as a thin neoprene (preferably 0.5 mm). This layer combines with layer 20 to protect layer 30 from water under pressure, but can be eliminated if other layers already provide waterproofness. If layer 30 is a 3D textile or other non hydrophobic textile that can get saturated with water then layers 20 and 40 may be needed for waterproof protection. If layer 30 is an aeorgel, such as PYROGEL 2250 (Trade Mark) by Aspen Aerogel (2 mm thick and low thermal conductivity of 0.015 W/mK at 20 degrees C. sea level atmospheric pressure) then the hydrophobic qualities of the aerogel itself help to eliminate the need for layer 40, and (optionally) layer 20 as well.

Layer 50 is an optional inside protective fabric for layer 40, if required. It can be a Tricot Mesh, for example, to protect layer 40 if it is a thin waterproof breathable membrane, such as Toray Dermizax or the like. Layer 50 can also be other fabrics, such as nylon, polyester or polypropelene.

Layer 60 is designed to reflect heat back to the body. The layer is metalized, preferably with aluminium or silver, to make it infrared reflective. Aluminium foil, for example, has been traditionally used in industrial insulation applications to great effect for this same function. In apparel, a silver or aluminium layer can similarly be applied. In order for this layer to also have moisture transfer ability, so the total garment can still breathe. The silver or aluminium, or compound of similar thermal attributes, can be applied as a powder added to a breathable adhesive that connects adjacent layers in total composite material. A heat reflective layer can also be made by exposing a fabric, preferably one that does not absorb water such as a polyester or polypropelene, to a vacuum plasma process in order to energise the surface of the exposed fibres and then applying a coating of a conductive material, preferably aluminium. This coating of aluminium can be ultra thin, typically 50 to 80 nm thick, and can be applied to just one side of the fabric. An acrylate, acrylic binder is then used to coat this aluminium coating in order to protect it from oxidization. This binder can be applied to both sides of the fabric. A pigment colour can also be optionally applied with the binder. The result is a fabric with an alumimium coating adhered to the fibres on one side of the fabric, so that it will have high heat reflection on one side, and still breath and stretch.

Layer 70 is designed as a layer that will wick moisture from the skin, or from layer 80, pull the moisture up and spread it out for transfer to outer layers for evaporation. It is also design to retain heat and act as a thermal layer. A good construction is a synthetic hollow core fleece, such that heat can interface to a maximum surface area to internally trapped air in each fibre, similar to the way natural fibres work in the fur of animals such as possums. This layer 70 can also be treated to have an antimicrobial function, using either natural (for example bamboo fibres) or synthetic (for example silver) agents. Another good heat retention material option is wool, which naturally absorbs some water that can help keep the skin dry, and retain heat in the right circumstances.

Layer 80 is optionally added to aid in the transfer of heat across the body, such that hot areas equalize with colder areas efficiently. To do this the layer is mixed with fibres that have high thermal conductivity. This layer is ideally made from a material that is also excellent at wicking moisture away from the skin. An example would be a thin synthetic layer such as filament polyester that is good for wicking yet also constructed with a mesh of silver, aluminium, or similar thermal conductive thread. This layer 80 can also be treated to have an antimicrobial function, using either natural (for example bamboo fibres) or synthetic (for example silver) agents. The heat reflective layer 60 can also act as a thermal conductor across the body to help equalize cold and hot areas, in which case layer 80 may not require that function.

Examples of composite fabrics made up using the invention disclosed here include the following

### Example 1

Per FIG. 1. An example fabric was constructed made up of layers 10,20,30,40,50,60,70 and 80 with the following respective materials in each layer: Layer 10 is nylon, preferably with a high density micro weave for durability and rip stop strength, where the fibres are treated for very high water repellency before knitting the material, using the latest nano technology methods; Layer 20 is a waterproof membrane that is monolithic with high waterproof specification, and using solid state diffusion for moisture vapour transport and breathability, chosen from those manufactured by either Toray, Amaterrace, 3M or the like; Layer 30 is a thin 3 mm 3D warp knit mesh, such as the spacer fabrics made by Tytex, Heathcoat, or Baltex Layer 40 is a membrane the same as Layer 20, Layer 50 is a Tricot Mesh to protect Layer 40, Layer 60 is a silver powder added to the adhesive to bond layer 70 which is a carbon hollow core fleece or similar and layer 80 is thin polypropelene final layer with antimicrobial treatment and threads of aluminium, or similar, mesh.

### Example 2

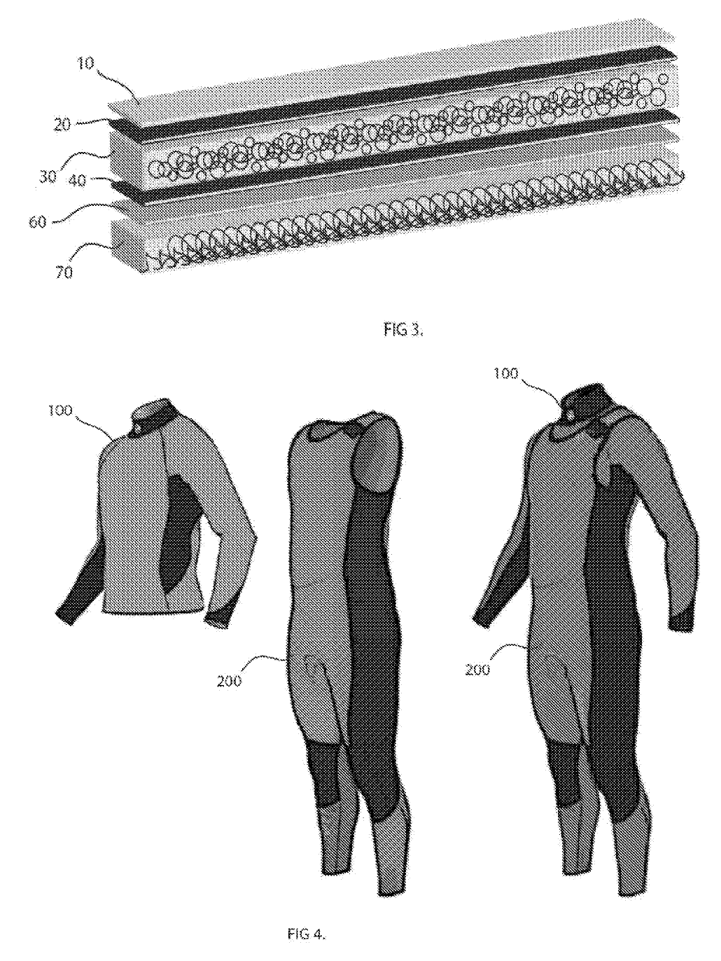

Per FIG. 3. an example fabric made up of layers 10,20,30,40,60 and 70 with the following respective materials in each layer: Outer nylon with super durable water repellency coating, thin neoprene (thickness of 0.5 mm), 3D warp knitted mesh (such as those made by company Tytex, Heathcoat, Baltex, or Muller-Textil), thin neoprene (thickness of 0.5 mm), adhesive combined with metallic particles (with Aluminium or Silver elements), and a nylon hollow core fleece with antimicrobial treatment.

### Example 3

Also Per FIG. 3 an example fabric made up of layers 10,20,30,40,60 and 70 with the following respective materials: Layer 10 of nylon with super durable water repellency, Layer 20 a monolithic waterproof breathable membrane such as Dermizax (Trade Mark) from Toray, Layer 30 a perforated 3 mm neoprene, with perforations of 1 mm diameter and spaced about 5 or so per square cm, Layer 40 is the same as Layer 20, Layer 60 is a metallic silver or aluminium powder added to the adhesive to layer 70, and layer 70 is a nylon hollow core fleece with antimicrobial treatment and high wicking properties. Each layer and its bonding method in this fabric is of high 4 way stretch and is breathable so the total function of the fabric is one with very high thermal insulation to the outside temperature, body heat reflection internally, and good breathability. The fabric can build tight fitting apparel excellent for performance sports, and also a replacement for wetsuits made for cold weather conditions.

### Example 4

Per FIG. 2. The outer fabric is made of layers 10,20,30,40,50 and 60, where Layer 10 is nylon with super durable water repellency, Layer 20 a monolithic waterproof breathable membrane such as Dermizax (Trade Mark) from Toray, Layer 30 is a thin 3 mm 3D warp knit mesh, such as the spacer fabrics made by Tytex, Heathcoat, or Baltex; Layer 40 is a membrane the same as Layer 20, Layer 50 is a Tricot Mesh to protect Layer 40, Layer 60 is a reflective lining and can be a very thin coating of powdered aluminium, or the metallic finishes as applied to neoprenes available by Sea Mate, or similar. The total outer fabric does not have to be very high stretch, but all layers are preferably be breathable. The inner fabric is made of layers 10, 60, 70, 80, with the following materials; Layer 10 is a high stretch nylon or spandex, layer 60 is an optional extra heat reflecting layer made with a metallic silver or aluminium powder added to the adhesive to layer 70, layer 70 is a nylon hollow core fleece with antimicrobial treatment and high wicking properties and Layer 80 is an optional thin high wicking polypropelene final layer with antimicrobial treatment and threads of aluminium, or similar, mesh. The inner fabric is tight fitting, high stretch, light weight and acts as the main thermal wear to retain heat close to the body, while the outer fabric provides outside weather insulation, durability and water repellency.

### Example 5

Per FIG. 2. Same outer fabric as Example 4. Inner fabric 92 is composite made of layers 10, 60, 70 and 80, where layer 10 is a polypropelene fabric, layer 60 is a reflective layer made by coating a very thin metallic, preferably aluminium, adhered to the fibres on one side of layer 10 via a vacuum plasma method and binded with an acrylic aqualate to prevent it from oxidization. Layer 70 is a heat retention layer, preferably wool (but optionally a polyester or polypropylene fleece or hollow core fleece), and layer 80 is a coating to enhance both hydrophilic wicking and optionally a antimicrobial treatment. This inner fabric 92 is stretchy and worn tight to the skin, providing very high thermal heat retention with the added layer 60 heat reflection layer, and also heat equalisation across the body via layer 60 thermal conduction. Layer 10 in the inner layer can also have an outer coating of water repellency treatment.

### Example 6

An example fabric constructed with all layers in FIG. 1 except without layers 30 and 40 with the following respective materials in each layer: Layer 10 is nylon and spandex mix with high stretch, and treated a durable water repellency coating; Layer 20 is a waterproof membrane that is monolithic with a high waterproof specification, and using solid state diffusion for moisture vapour transport and breathability, chosen from those manufactured by either Toray, Amaterrace, 3M or the like; Layer 50 is a polypropylene fabric, layer 60 is a reflective layer made by coating a very thin metallic, preferably aluminium, adhered to the fibres on one side of layer 50 via a vacuum plasma method and binded with an arcyllic aqualate to prevent it from oxidization. Layer 70 is a heat retention layer, preferably wool (but optionally a polyester or polypropelene fleece or hollow core fleece), and layer 80 is a coating to enhance both hydrophilic wicking and optionally a antimicrobial treatment.

All inner lining materials may include anti-microbial FOSSHIELD (Trade Mark) silver fibers and grooved 4-8 DG fibers by Foss Manufacturing or the like or X-STATIC (Trade Mark) products or the like.

The examples presented above are various composite combinations presented in preferred embodiments. The technical composites can be realized on different parts in different types of apparel or as the entire garment. Other variations are also possible given the range of combinations that are possible. It may be noted in the preferred embodiments that there are no stated specified rates of breathability or moisture transfer. The selected products and performance category in the product line determine the selected breathable and moisture transfer rates. The MVT and breathable rates are developed by the selected fibers, foams and materials for these technical composites product systems and are determined by the performance level and product company.

Any layers above could use microfiber technology, and this area is rapidly developing and changing, so there is potential for improved performance of products as newer materials become available and are properly utilized. These new products are part of rapidly developing technical textile technology. The present invention employs a combination of fabrics, foam layers, nonwovens, spacer fabrics, breathable membranes, encapsulated technology, structurally woven water repellent fabrics, or waterproof film coatings in such combinations that increase the performance of the products in which they are used as well as increase the breathability. There are many new membranes on the market to select from with excellent breathable and moisture transfer properties.

Garments manufactured in accordance with preferred embodiments will typically use a stitching method that is waterproof. Many of the stitching methods commonly used for wet weather apparel can be used, with taped seams. The seams could also be sonically bonded. If the garment also needs to have high stretch then a combination of flatlock and liquid glue can be used, or in the case of a fabric made with foam of sufficient thickness, the seams could be glued and blind stitched.

If the cuffs of the garment need to have waterproof seals, then the cuffs could be latex, (preferably DURASEAL (Trade Mark) from Precision Dippings with higher resistance to ozone and UV.)

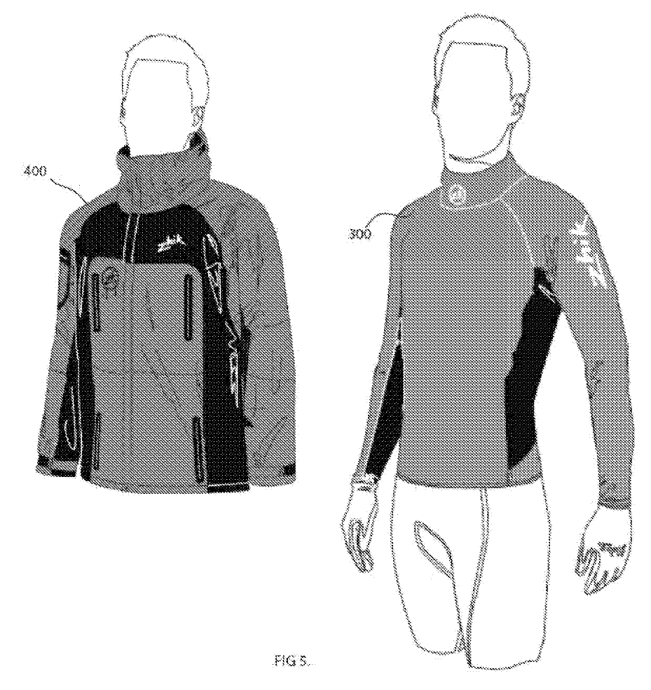

FIG. 4 illustrates an example of performance apparel made using the fabrics of the preferred embodiments, which combine a long john style garment 200 as a replacement to a wetsuit, with a Veclro (Trade Mark) shoulder entry, and a technical top 100 made of a similar fabric. The combination of the two makes a system with good flexibility around the shoulders, and an automatic doubling of the fabric around the chest and back. This combination also provides total body coverage with no zips, which makes it more flexible, less expensive, and more durable.

The apparel illustrated in FIGS. 4-5 are specific style, and although not specifically illustrated, all of the types of apparel can be manufactured according to the present invention. The application of this invention to other types of apparel could easily be accomplished by one with ordinary skill in the art.

FIG. 5 illustrates an example set of garments using the system of fabrics in FIG. 2, made using two technical tops, one worn under the other. The inner garment 300 is stretchy and close fitting to maximize the effect of the heat retention fabric. The outer garment 400 is a more loose fitting jacket with less stretch, that is durable and weather proof providing insulation and shield to outside climate.

Another example would be dry suits for very cold conditions, using latex seals to make them completely waterproof. This could be in a top and pant combination, with a watertight seal around the waist and no heavy zips or a total full body dry suit, with a waterproof zip entry, typically across the back.

### Interpretation

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Although the present invention has been described with particular reference to certain preferred embodiments thereof, variations and modifications of the present invention can be effected within the spirit and scope of the following claims.

1.-27. (canceled)

28. A water resistant composite for apparel or footwear including:
a layer of high thermal insulation made from foam, perforated foam, particle filled coating or aerogel;
at least one waterproof membrane coating the layer of high thermal insulation; and,
a metallic heat reflection layer applied to the layer of high thermal insulation or the waterproof membrane via plasma treated vapour deposition in a vacuum.

29. The composite according to claim 28 wherein said composite has a high stretch and a breathable nature.

30. The composite as claimed in claim 28 further comprising a supporting fabric made from hydrophobic material.

31. The composite as claimed in claim 28 further comprising a supporting fabric made from a polyester or polypropelene.

32. The composite as claimed in claim 28 wherein said reflection layer is further coated with an acrylic binder to protect it from oxidization.

33. The composite as claimed in claim 28 further comprising an inner heat retention layer of wool, cotton, synthetic fleece, or hollow core synthetic fleece.

34. The composite as claimed in claim 28 further comprising a metallic aluminum heat reflection layer combined with a thermal heat retention layer of synthetic fleece.

35. The composite as claimed in claim 28 wherein at least one of said layers includes an antimicrobial treatment.

36. Apparel for clothing an individual, comprising,
a layer of high thermal insulation provided using foam, perforated foam, particle filled coating or aerogel;
at least one waterproof membrane coating the layer of high thermal insulation; and,
a metallic heat reflection layer comprising a metallic compound applied to the layer of high thermal insulation via a plasma treated vapour deposition in a vacuum.

37. The apparel for clothing an individual according to claim 36, further comprising a high stretch inner garment combined with a low stretch outer shell, where the two garments together provide a thermal system where the outer layer acts as a water repellent insulating shell and the inner high stretch garment is made from a hollow core fleece with a heat reflection layer.

38. A composite for apparel or footwear comprising:
an inner layer made of polyester, or polypropylene, or wool, or mix, or other synthetic textile, laminated or otherwise bound to an outer layer of polypropylene, polyester, or wool, or cotton, or nylon, or nylon and spandex mix or other mix of supporting material, the said outer layer coated on the face adjacent to the inner layer with a reflecting layer of metallic aluminium or silver applied to the fibres of a supporting outer fabric via a plasma treated vapour deposition in a vacuum.

39. The composite according to claim 38 wherein the said reflecting layer is coated on the outer face of the inside layer adjacent to the outer layer before lamination to the outer layer.

40. The composite according to claim 38 wherein said composite has a high stretch and breathable nature.

41. The composite according to claim 38 wherein said reflecting layer is coated with an acrylic binder to protect it from oxidization.

42. The composite as claimed in either claim 38 whereby an additional layer of hydrophobic treated nylon, or nylon and spandex mix, or other supporting material, is applied to the outer layer with the inclusion of a waterproof membrane between the additional layer and the outer layer.

43. The composite as claimed in claim 38 where a layer of neoprene insulation is laminated to the outer layer.

44. The composite as claimed in claim 43 where a layer of nylon or nylon and spandex mix, is laminated to an outer surface of the neoprene insulation.

45. The composite as claimed in claim 44 where the outer layer is coated with a hydrophobic treatment.

46. A composite for apparel or footwear comprising an inner layer of polyester, polypropylene, wool, mix, or other synthetic textile, laminated or otherwise bound to an outer layer of neoprene, with the said inner layer coated with an reflecting layer of metallic aluminium or silver applied to the fibres via plasma treated vapour deposition in a vacuum on the side of the fabric that is laminated to the outer layer of neoprene.

47. The composite as claimed in claim 46 further comprising a protective layer of nylon or nylon and spandex mix, or similar fabric laminated to an outer surface of the neoprene insulation.

48. The composite as claimed in claim 47 wherein the protective layer is coated with a hydrophobic treatment.

49. The composite according to claim 46 wherein said reflecting layer is coated with an acrylic binder to protect it from oxidization.
